(19) United States
(12) Patent Application Publication
(10) Pub. No.: US 2014/0133016 A1
(43) Pub. Date: May 15, 2014

(54) ILLUMINATION OPTICAL SYSTEM AND MICROSCOPE

(71) Applicant: CANON KABUSHIKI KAISHA, Tokyo (JP)

(72) Inventor: Hiroshi MATSUURA, Utsunomiya-shi (JP)

(73) Assignee: CANON KABUSHIKI KAISHA, Tokyo (JP)

(21) Appl. No.: 14/078,628

(22) Filed: Nov. 13, 2013

(30) Foreign Application Priority Data
Nov. 15, 2012 (JP) 2012-251244

(51) Int. Cl. G02B 21/06

(52) U.S. Cl. CPC G02B 21/06
USPC 359/385

(57) ABSTRACT

The illumination optical system illuminates an object plane on which a sample is placed in a microscope. The illumination optical system includes three light source areas arranged apart from one another in a pupil plane of the illumination optical system and being coherent with one another. Distances from centers of the three light source areas to a center of a pupil of the illumination optical system are different from one another. A condition of

$$p = \frac{\sqrt{1 - {12}^{2}} - \sqrt{2 - {11}^{2}}}{\sqrt{1 - {13}^{2}} - \sqrt{1 - {11}^{2}}}$$

is satisfied where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium.

### BACKGROUND OF THE INVENTION

The present invention relates to an illumination optical system for illuminating a sample in a microscope, and particularly to an illumination optical system which is appropriate for a three-dimensional fluorescence microscope.

Observation of biological samples by microscopes, particularly, by fluorescence microscopes is essential to biological studies including applications to medical science. However, when a thick sample is observed by using general fluorescence microscopes, an image where images at all heights inside the sample through which light passes are overlapped is observed. In other words, in addition to an image in a plane (in-focus plane) at an in-focus height, blurred images in planes (out-of-focus planes) at out-of-focus heights are overlapped to be observed. Thus, in the general fluorescence microscopes, it is not possible to selectively separate and extract only an image in a desired in-focus plane. An effect of selectively separating and extracting only such an image in the desired in-focus plane is called “a sectioning effect.”

Fluorescence microscopes configured to provide the sectioning effect based on various mechanisms are each referred to as “a three-dimensional fluorescence microscope” and are distinguished from the general fluorescence microscopes. The sectioning effect makes it possible to produce a three-dimensional stereoscopic image by laminating images in an arbitrary in-focus plane on a computer. In other words, three-dimensional view of cell arrangements, which has been performed in brains of experienced pathologists or the like so far, can be performed by any person through digital processing.

As a representative three-dimensional fluorescence microscope, a confocal microscope is used. The confocal microscope arranges a pinhole at a light-converging point of light from a desired in-focus plane to cause only the light to pass therethrough and thereby blocks weakly converged light from out-of-focus planes. Although such a confocal microscope provides a high sectioning effect, an area that can be captured at one time is small as a dotted shape, and thus scanning is necessary in order to observe an entire area of a sample.

On the other hand, as a method of implementing the sectioning effect by using an image process performed by a computer, a structured illumination method (see M. A. A. Neil and T. Wilson, “Method of obtaining optical sectioning by using structured light in a conventional microscope,” Opt. Lett. 22, 1905 (1997)) is proposed. This method produces a situation where an illumination intensity on an object plane changes, for example, in a sinusoidal wave manner and shifts its phase to acquire multiple images in which a sinusoidal structure is translated. Then, the method performs an image process on the multiple images by a computer so as to provide the sectioning effect. This method requires producing a sinusoidal structure whose phase, that is, position is controlled with high accuracy.

In addition, a method of using speckles generated at random as illumination is known (see U.S. Patent Application Publication No. 2010/0224796, C. Ventalon and J. Mertz, “Quasi-confocal fluorescence sectioning with dynamic speckle illumination.” Opt. Lett. 30, 3350-3352(2005), C. Ventalon and J. Mertz, “Dynamic speckle illumination microscopy with translated versus randomized speckle patterns.” Opt. Express 14, 7198-7209(2006), C. Ventalon, R. Heintzmann, and J. Mertz, “Dynamic speckle illumination microscopy with wavelet prefiltering.” Opt. Lett. 32, 1417-1419(2007), Daryl Lim, Kengyeh K. Chu, and Jerome Mertz, “Wide-field fluorescence sectioning with hybrid speckle and uniform-illumination microscopy,” Opt. Lett. 33, 1819-1821(2008), and Daryl Lim, N. Ford, Kengyeh K. Chu, and Jerome Mertz, “Optically sectioned in vivo imaging with speckle illumination HiLo microscopy” Journal of Biomedical Optics. 16, 016014(2011)). Although this method also uses an image process performed by a computer, since an illumination intensity on an object plane depends on the random speckles, non-uniform intensity unevenness occurs in a final image, which deteriorates image quality thereof.

From the above problems, development of a high-performance three-dimensional fluorescence microscope capable of providing the sectioning effect without requiring a high degree of accuracy for scanning of the object plane and the illumination optical system is demanded.

### BRIEF SUMMARY OF THE INVENTION

The present invention provides an illumination optical system especially suitable for achievement of the above high-performance three-dimensional fluorescence microscope and provides a microscope using the illumination optical system.

The present invention provides as one aspect thereof an illumination optical system to illuminate an object plane on which a sample is placed in a microscope for observation of the sample. The illumination optical system includes three light source areas arranged apart from one another in a pupil plane of the illumination optical system and being coherent with one another, distances from centers of the three light source areas to a center of a pupil of the illumination optical system being different from one another. The following condition is satisfied:

$$p = \frac{\sqrt{1 - {12}^{2}} - \sqrt{1 - {11}^{2}}}{\sqrt{1 - {13}^{2}} - \sqrt{1 - {11}^{2}}}$$

where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,

$$0.4 \leq p \leq 0.6$$

$$l 1 l 2 l 3 {q}^{3} - ( l {1}^{2} + l {2}^{2} + l {3}^{2} ) {q}^{2} + 1 = 0$$

$$q = \frac{cos ( θ2 - θ3 )}{l 1} = \frac{cos ( θ3 - θ1 )}{l 2} = \frac{cos ( θ1 - θ2 )}{l 3} , and$$

$$NA / n \geq l 1 > l 2 > l 3 \geq 0.$$

The present invention provides as another aspect thereof an illumination optical system to illuminate an object plane on which a sample is placed in a microscope for observation of the sample. The illumination optical system includes three light source areas arranged apart from one another in a pupil plane of the illumination optical system and being coherent with one another, distances from centers of the three light source areas to a center of a pupil of the illumination optical system being different from one another. The following condition is satisfied:

$$p = \frac{\sqrt{1 - l {2}^{2}} - \sqrt{1 - l {1}^{2}}}{\sqrt{1 - l {3}^{2}} - \sqrt{1 - l {1}^{2}}}$$

where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,

$$0.4 \leq p \leq 0.6$$

$${r}^{2} ( l {2}^{2} + l {3}^{2} ) - l {1}^{2} + 2 ( 1 - {r}^{2} ) l 1 l 2 l 3 q - l {2}^{2} l {3}^{2} {q}^{2} = 0$$

$$0.9 \leq r \leq 1.1$$

$$q = \frac{cos ( θ2 - θ3 )}{l 1} = \frac{cos ( θ3 - θ1 )}{l 2} = \frac{cos ( θ1 - θ2 )}{l 3}$$

r represents a ratio H/A in which A represents a length of a shortest side of a triangle formed by connecting the positions of the three light source areas and H represents a height of the triangle from the shortest side as a base of the triangle, and

NA/n≧l1>l2>l3≧0.

The present invention provides as still another aspect thereof a microscope including any one of the above illumination optical systems and an imaging optical system through which a sample placed on an object plane illuminated by the illumination optical system is observed.

Other aspects of the present invention will be apparent from the embodiments described below with reference to the drawings.

### BRIEF DESCRIPTION OF THE DRAWINGS

FIGS. 1A and 1B each show a uniformly-illuminated object O.

FIGS. 2A and 2B each show a speckle-illuminated object O.

FIG. 3A shows a difference between the images shown in FIGS. 1A and 2A, and FIG. 3B shows a difference between the images shown in FIGS. 1B and 2B.

FIG. 4 schematically shows an area where a spatial dispersion value of intensity is calculated in a vicinity of a point (x, y) in FIGS. 3A and 3B.

FIG. 5 shows non-uniformity of σ(x, y, z) in an x-y direction.

FIG. 6A shows an example of a pupil function for achieving an illumination light intensity distribution in a comb function manner. FIG. 6B shows an actual illumination light intensity distribution provided when that pupil function is used.

FIG. 7 shows an illumination light intensity distribution provided in a plane at z=±2 μm of a sample when an illumination optical system having the pupil function shown in FIG. 6A is used.

FIG. 8 shows a fluorescence intensity distribution provided in a plane at z=0 μm of a sample when an object O2 is illuminated by using the illumination optical system having the pupil function shown in FIG. 6A.

FIGS. 9A and 9B respectively show a pupil function P2 and an illumination light intensity distribution in the plane at z=0 μm of a sample when an illumination optical system having the pupil function P2 is used in Embodiment 1 of the present invention.

FIG. 10 shows a fluorescence intensity distribution provided in a plane at z=0 μm of a sample when the object O2 is illuminated by using the illumination optical system having the pupil function shown in FIG. 9A.

FIG. 11 shows a pupil function P representing arrangement of coherent light fluxes in a pupil plane in Embodiment 1.

FIGS. 12A, 12B and 12C show a lateral shift of the illumination light intensity distribution due to its positional shift in a z direction in Embodiment 1.

FIG. 13 shows arrangement of light fluxes in the pupil plane when periods of the illumination light intensity distribution in x and y directions are equal to each other in Embodiment 1.

FIG. 14 schematically shows a configuration of an illumination optical system designed on a basis of an illumination design method employed in Embodiment 1 in a general fluorescence microscope.

FIG. 15 shows a pupil function having a symmetric component, which is used as a comparison with Embodiment 2 of the present invention.

FIGS. 16A and 16B show a process of deciding coordinates of the pupil function and an example of arrangement thereof in Embodiment 1.

FIG. 17 shows a relation between input variables and image quality in Embodiment 2.

FIGS. 18A and 18B show a process of deciding coordinates of the pupil function and an example of arrangement thereof in Embodiment 3 of the present invention.

### DETAILED DESCRIPTION OF THE EMBODIMENTS

Exemplary embodiments of the present invention will be described below with reference to the accompanied drawings.

### Embodiment 1

An illumination optical system that is a first embodiment (Embodiment 1) of the present invention can be used, for example, for a three-dimensional microscope for observation of a sample as a self-illuminant whose luminous mechanism is fluorescence or phosphorescence. The microscope may be an epi-illumination microscope or a transmitted illumination microscope.

As a specific example, the illumination optical system of Embodiment 1 is applicable to a microscope for observation of a sample fluorescently dyed as an object (specimen); the microscope is used for a digital slide scanner. The digital slide scanner is an apparatus which scans a prepared sample used in a biological or pathological examination at a high speed and converts the scanned image into high resolution digital data. In addition, the illumination optical system of Embodiment 1 may be used to provide a sectioning effect to, for example, a digital slide scanner having a projection optical system with a large numerical aperture (NA) or a general fluorescence microscope.

Prior to a detailed description of the illumination optical system of Embodiment 1, description will be made of problems of a conventional method using speckle.

Daryl Lim, Kengyeh K. Chu, and Jerome Mertz, “Wide-field fluorescence sectioning with hybrid speckle and uniform-illumination microscopy.” Opt. Lett. 33, 1819-1821(2008) and Daryl Lim, N. Ford, kengyeh K. Chu, and Jerome Mertz, “Optically sectioned in vivo imaging with speckle illumination HiLo microscopy” Journal of Biomedical Optics. 16, 016014(2011) discloses a method of extracting only an image of a fluorescent object placed on an in-focus plane by using two images of an image 1 illuminated with a uniform intensity and an image 2 illuminated with speckle. According to the disclosure, an image 3 representing an intensity difference between the image 1 and the image 2 is first produced by a computer. Illuminating an object with speckle can be made by inserting an element such as an obscure glass which provides a random phase disturbance, into a pupil of an illumination optical system including a light source emitting a coherent excitation light. For simplifying the description, a case of O(x,y,z)=δ(z) is considered where O(x,y,z) represents an intensity distribution of a fluorescent object. In the description hereinafter, the intensity distribution O(x,y,z) of the fluorescent object is also simply referred to as “an object O”. The object O is a virtual object which has a locally uniform intensity distribution only in a plane at z=0 and has a uniform intensity distribution in an x-y direction. In addition, the plane at z=0 is defined as an in-focus plane. Moreover, planes at z=±a (a>0) are defined as representatives of out-of-focus planes.

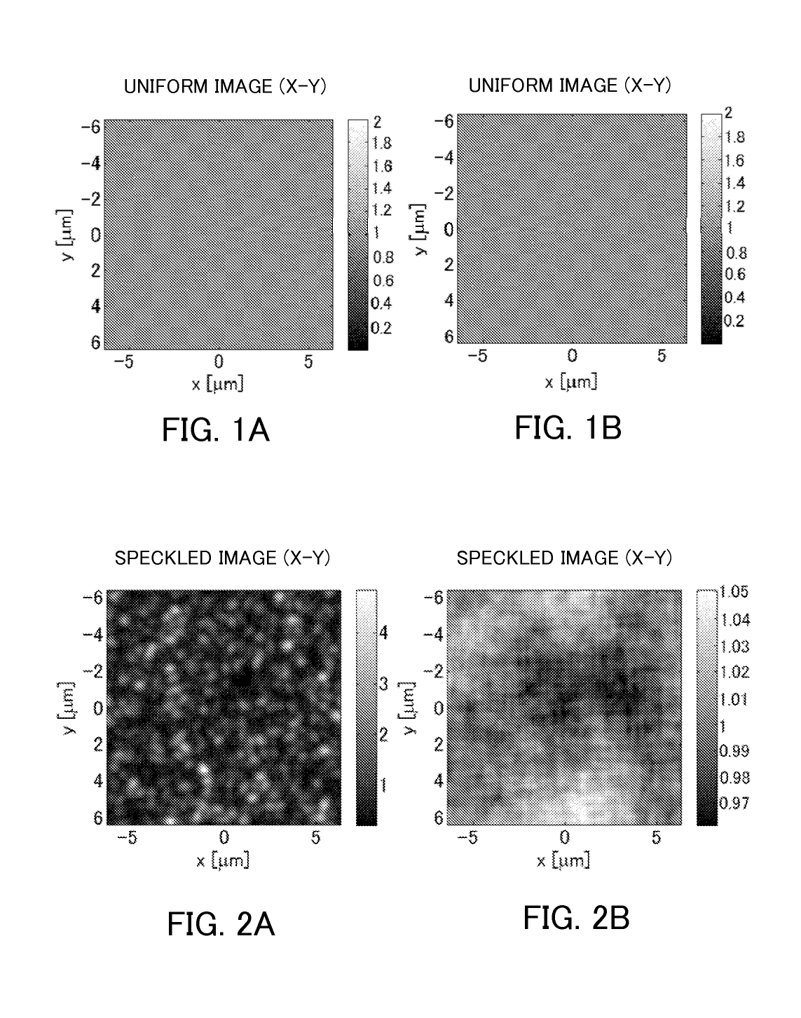

FIG. 1A shows an image obtained by observing the object O illuminated with an illumination having a uniform intensity distribution in a state where focus is on the in-focus plane. The image captured under such an illumination having a uniform intensity distribution is represented by Is(x,y,z). In addition, FIG. 1B shows an image obtained by observing the object O illuminated with the same illumination in a state where focus is on the out-of-focus plane. These images correspond to the above-described image 1.

Moreover, FIG. 2A shows an image obtained by observing the object O illuminated with speckle in a state where focus is on the in-focus plane. In addition, FIG. 2B shows an image obtained by observing the object O illuminated with the same speckle illumination in a state where focus is on the out-of-focus plane. These images correspond to the above-described image 2.

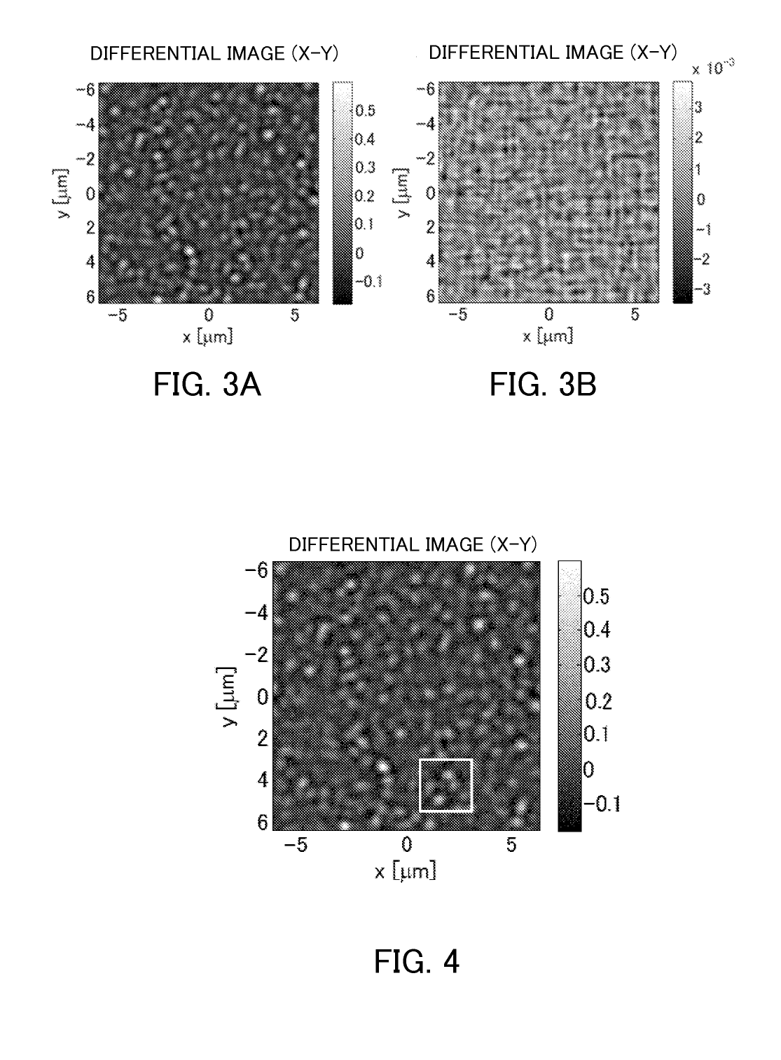

In addition, FIG. 3A shows an image representing a difference between an intensity distribution of the image shown in FIG. 1A and that of the image shown in FIG. 1B. Furthermore, FIG. 3B shows an image representing a difference between an intensity distribution of the image shown in FIG. 2A and that of the image shown in FIG. 2B. These images correspond to the above-described image 3.

As understood from FIGS. 1A and 1B, when image capturing is performed by using a general uniform illumination, the image obtained in the state where focus is on the plane at z=0 where the object O actually exists and the image obtained in the state focus is on the plane at z=±a (a>0) where the object O does not exist are completely the same, so that the images cannot be distinguished from each other. Therefore, it can be understood that a general fluorescence microscope has no sectioning effect.

Daryl Lim, kengyeh K. Chu, and Jerome Mertz, “Wide-field fluorescence sectioning with hybrid speckle and uniform-illumination microscopy.” Opt. Lett. 33, 1819-1821(2008) and Daryl Lim, N. Ford, kengyeh K. Chu, and Jerome Mertz, “Optically sectioned in vivo imaging with speckle illumination HiLo microscopy” Journal of Biomedical Optics. 16, 016014(2011) discloses a method of extracting data reflecting an intensity distribution of an actual fluorescent object from the images 1 and 2. More specifically, the method inputs the images shown in FIGS. 3A and 3B to a computer to calculate a spatial dispersion value σ of an intensity difference in a region (indicated as a white region in FIG. 4) in a vicinity of a point (x,y). Then, the method produces a dispersion value map σ(x,y,z) from the dispersion values thus obtained. In this method, as can be easily understood from FIGS. 3A and 3B, in the image shown in FIG. 3A corresponding to an image in which light from the in-focus plane is processed, contrast of black and white is sharp, so that a spatial dispersion value σ(x,y,0) becomes high. On the other hand, in the image shown in FIG. 3B corresponding to an image in which light from the out-of-focus plane is processed, there is almost no contrast due to blur of a speckled image. Therefore, a spatial dispersion value σ(x,y,a) becomes a uniform value which is almost close to 0.

Accordingly, when I(x,y,z) is calculated by using the following expression (1), I(x,y,z) becomes an image acquiring the sectioning effect depending on σ(x,y,z). Namely, I(x,y,0) has a value, but I(x,y,a) has almost no value.

I(x,y,z)==Iu(x,y,z)·σ(x,y,z) (1)

where Iu(x,y,0) represents an image captured by using the general uniform illumination.

In this manner, it is possible to reconstruct an image which is approximate to an actual object O in a computer. However, this method uses as the illumination a speckle phenomenon which is essentially a random phenomenon, so that the method has inevitable defects. Description of the defects will hereinafter be made.

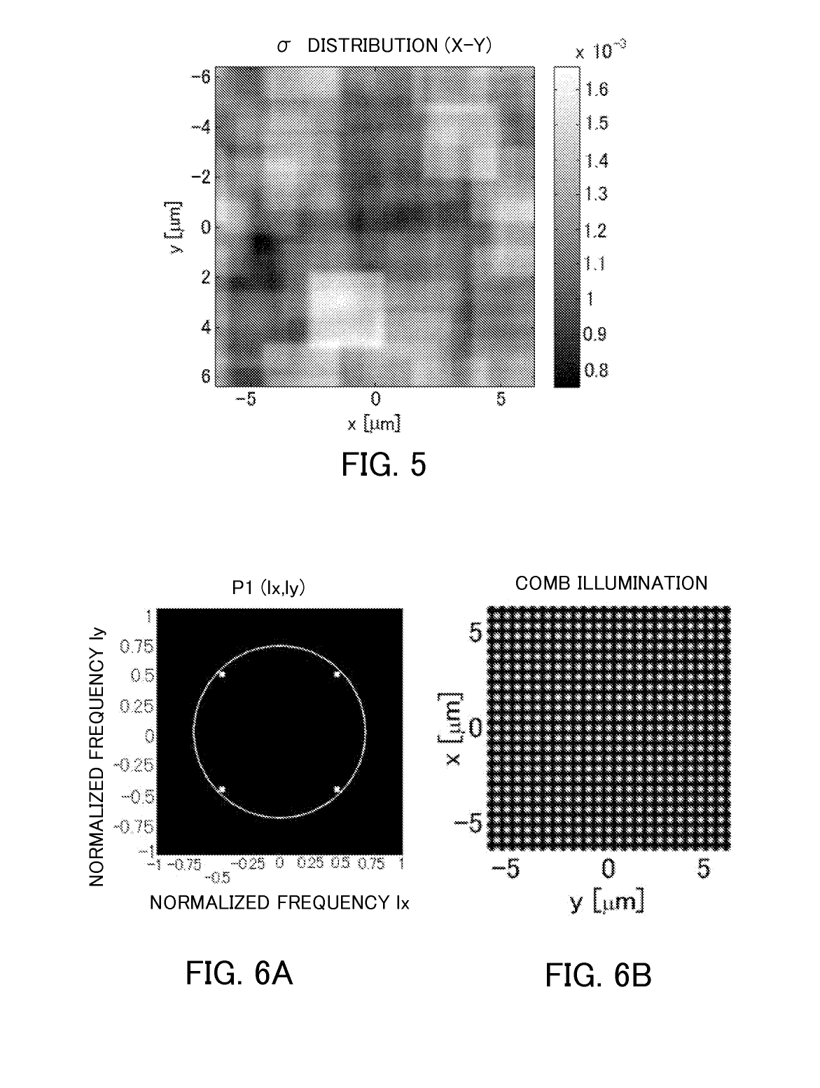

I(x,y,0) expected originally is Iu(x,y,0) which is uniform in the x-y direction as shown in FIG. 1A. That is, σ(x,y,0) is also expected to be uniform in the x-y direction. However, as shown in FIG. 5, in actual cases, σ(x, y, 0) is not uniformed in the x-y direction. This is so-called illumination unevenness caused by non-uniform distribution of speckle. The illumination unevenness deteriorates image quality of a final image I(x,y,0) to greatly deteriorate.

Thus, this embodiment provides an illumination method providing the sectioning effect while preventing such image quality deterioration due to the illumination unevenness. Description of its principle will hereinafter be made.

This embodiment is based on the following mathematical fact. Generally, a function represented by the following expression (2) is called a comb function.

comb(x,y)=Σδ(x−mp)δ(y−na) (2)

where δ represents a Dirac's delta function, a represents a distance (pitch) between points having infinite values in a direction along a coordinate axis, and Σ represents summation of δ(x−mp)δ(y−na) in which m and n are integers in a range of −∞<m and n<∞.

The mathematical fact relating to the comb function is that, as represented by the following expression (3), a Fourier transform of the comb function provides a comb function having a pitch of 1/a.

F[comb(x,y)](lx,ly)=Σδ(lx−m/a)δ(ly−n/a) (3)

where F is a symbol denoting the Fourier transform, and lx and ly respectively represent spatial frequencies corresponding to x and y.

In general, a Fourier transform of an amplitude distribution P(lx,ly) (pupil function) in a pupil of an optical system provides an amplitude distribution in an image plane. In a case where the optical system is an illumination optical system, a numerical value obtained by squaring an absolute value of the amplitude distribution in the image plane shows an intensity distribution of light illuminating a sample (object). Therefore, setting the amplitude distribution P(lx,ly) of the illumination optical system in a comb function manner makes it possible to provide a comb function-like illumination light. The comb function-like illumination light provides a uniform light intensity distribution with a uniform pitch on the object plane, which makes it possible to prevent generation of the illumination unevenness.

Daryl Lim, kengyeh K. Chu, and Jerome Mertz, “Wide-field fluorescence sectioning with hybrid speckle and uniform-illumination microscopy.” Opt. Lett. 33, 1819-1821(2008) and Daryl Lim, N. Ford, kengyeh K. Chu, and Jerome Mertz, “Optically sectioned in vivo imaging with speckle illumination HiLo microscopy” Journal of Biomedical Optics. 16, 016014(2011) discloses that, setting a pitch of the illumination light on the object plane as fine as possible makes it possible to reduce a size of calculation area of σ shown in FIG. 4 and thereby improves resolution performance in a horizontal direction. Therefore, it is desirable that the pitch of the illumination light on the pupil plane of the illumination optical system be as large as possible. In fact, since a pupil of an optical system has only a limited size, it is not possible to realize an illumination which infinitely continues in the lx and ly directions as represented by expression (3). However, employing only a minimal constituent unit of the comb function as the amplitude distribution on the pupil plane makes it possible to realize an illumination light having no illumination unevenness.

Such an illumination light having no illumination unevenness will be described with reference to FIGS. 6A and 6B. FIG. 6A shows an illumination as P(lx,ly) employing a minimum pitch (square pitch) appearing in the comb function expressed by expression (2). In addition, FIG. 6B shows an illumination intensity on the object plane by that illumination. In this description, the illumination light has a wavelength λ of 512 nm, the illumination optical system has a numerical aperture NA of 0.7, and a medium has a refractive index n of 1. The pupil of the illumination optical system is normalized by a radius represented by NA/n. Coordinates of positions at which amplitudes appear are as follows:
(0.7/√2,0.7/√2);
(−0.7/√2,0.7/√2);
(−0.7/√2,−0.7/√2); and
(0.7/√2,−0.7/√2).

Using the above-described method of calculating σ(x,y,0) for an object illuminated with the periodical illumination light shown in FIG. 6B makes it possible to provide, since there is no illumination unevenness, σ(x,y,0) having a significantly high uniformity.

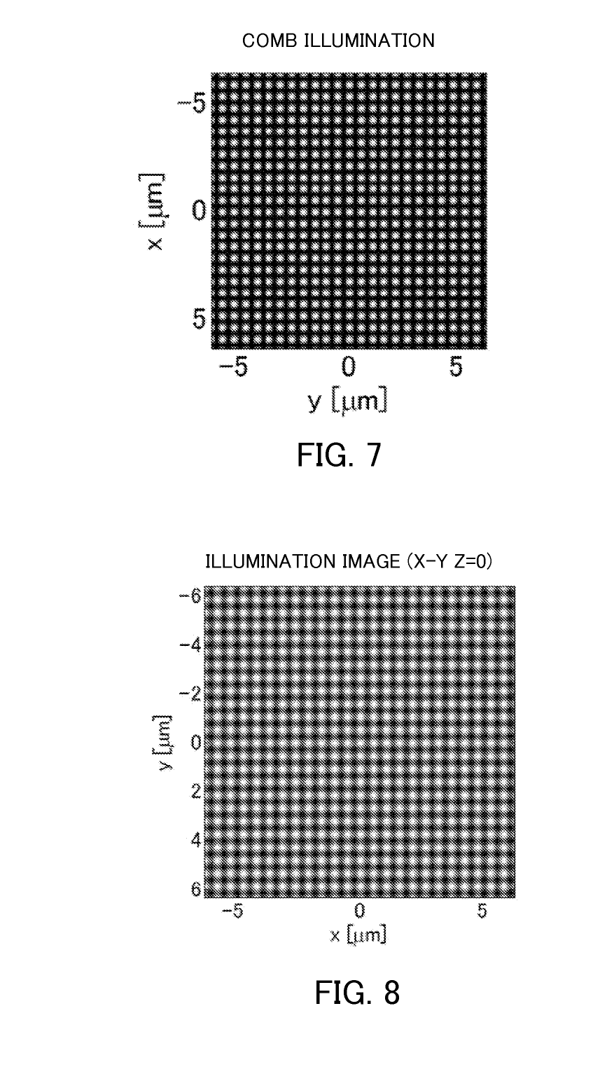

However, the illumination shown FIG. 6A has a considerable defect. It is known that, when such a pupil function P(lx,ly) of the illumination optical system is used, an illumination distribution at a position away from the image plane (that is, from the object plane) is not almost blurred as shown in FIG. 7.

FIG. 7 shows an illumination light distribution at a position of z=±2.0 μm. In comparison of FIG. 7 with FIG. 6B, it can be understood that the blur cannot almost be identified. In order to describe this situation which has a problem under such circumstances, an object O2(x,y,z)=δ(z+1)+δ(z−1) is considered. A unit of z is μm.

In a case of capturing the object O2, it is necessary that the object O2 have no intensity at z=0. If the object O2 has an intensity, it is necessary that the intensity at z=0 be much lower than an intensity in an image captured at z=±1.

If a fluorescent object located at z=1 above the object O2 and a fluorescent object located at z=−1 below the object O2 are illuminated with illuminations having almost the same shape, since the illumination shown in FIG. 6A has a small blur amount, a comb function-like fluorescence coming from the fluorescent object above the object O2 to the position of z=0 and a comb function-like fluorescence coming from the fluorescent object below the object O2 to the position of z=0 exactly overlap each other, so that a light intensity distribution having a significantly high contrast is formed. This light intensity distribution formed at z=0 is shown in FIG. 8. As described above, the state having a high contrast increases the value of σ(x,y,0). As a result, an image is obtained in which a fluorescent object seems to exist at the position of z=0 where the object O2 is not supposed to exist actually.

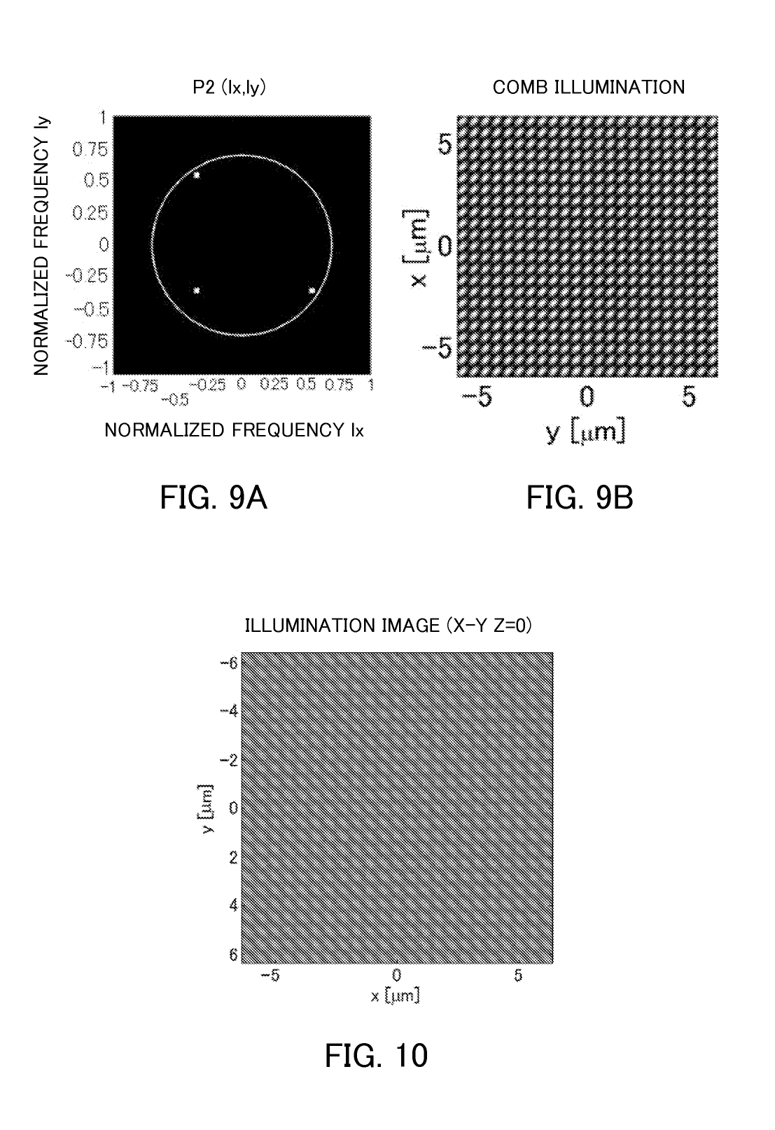

Thus, this embodiment uses, as a pupil function (amplitude distribution) P(lx,ly) in the pupil plane of the illumination optical system for solving the problem, P2(lx,ly) shown in FIG. 9A. In other words, this embodiment employs, in an orthogonal coordinate system in the pupil plane of the illumination optical system normalized by the radius NA/n, a configuration in which a centroid of three points formed by an illumination light flux is shifted from a center (origin) of the pupil plane. That is, this embodiment makes the amplitude distribution on the pupil plane asymmetric with respect to the origin.

The three points formed by the illumination light flux can be also said as three mutually coherent light source regions (for example, point light sources each having minute area) formed on the pupil plane. Accordingly, the centroid of the three light source regions is shifted from the center of the pupil plane, in other words, at least one of distances from the centers of the three light source regions to the center of the pupil plane is different from at least another one of the distances. It is desirable that each light source region be a region whose ratio of its size to the radius of the pupil is less than 0.3. The configuration in which at least one of the distances is different from at least another one of the distances corresponds to a configuration in which all the distances are different from each other or only one distance is different from the other two same distances. However, this embodiment describes the case where the three distances are different from each other.

FIG. 9B shows an intensity distribution of the illumination light on an actual object plane. Since an illumination pattern is a periodic pattern, there is no illumination unevenness. P2 represents a pupil function intentionally set to be asymmetric with respect to the origin. An effect of such a pupil function P2 in which multiple coherent light sources are intentionally arranged to be asymmetric with respect to the origin (center of the pupil) appears as, since the illumination light is caused to obliquely enter the object, a lateral shift of the intensity distribution of the illumination light with change of z.

In order to verify the effect, a situation is considered where the fluorescent object (upper fluorescent object) located at z=1 above the object O2 and the fluorescent object (lower fluorescent object) located at z=−1 below the object O2 are illuminated by the laterally shifted illumination formed by P2. In this case, the fluorescence coming from the upper fluorescent object to the position of z=0 and a laterally shifted fluorescence coming from the lower fluorescent object to the position of z=0 do not exactly overlap each other, but are shifted from each other, so that a light intensity distribution having a significantly low contrast is formed, as shown in FIG. 10. In comparison of FIG. 10 with FIG. 8, it is understood that the contrast is very low and that the method of this embodiment makes it possible to prevent an unnecessary portion at z=0 from being resolved.

As described above, using the illumination whose illumination pattern is a grid pattern and which makes the amplitude distribution on the pupil plane asymmetric with respect to the origin in combination with the method disclosed in Daryl Lim, kengyeh K. Chu, and Jerome Mertz, “Wide-field fluorescence sectioning with hybrid speckle and uniform-illumination microscopy.” Opt. Lett. 33, 1819-1821(2008) and Daryl Lim, N. Ford, kengyeh K. Chu, and Jerome Mertz, “Optically sectioned in vivo imaging with speckle illumination HiLo microscopy” Journal of Biomedical Optics. 16, 016014(2011) can provide a good image including no intensity unevenness, without performing scanning which requires a long time.

Therefore, this embodiment decides, by the following method, the pupil function P of the illumination which produces the grid pattern illumination and makes the amplitude distribution on the pupil plane asymmetric with respect to the origin. Prior to description of conditions to decide the pupil function P, description will be first made of a correspondence relation between a projection direction of the illumination light flux from each of the three light source regions to the object (sample) and coordinates of the three light source regions on the pupil plane. In a cylindrical coordinate system, the projection direction of the illumination light flux from each of the three light source regions onto the object is expressed by the following expression (4) using a unit vector having a length of 1.

(l1,θ1,\sqrt{1−l1²})

(l2,θ2,\sqrt{1−l2²})

(l3,θ3,\sqrt{1−l3²}) (4)

where l1, l2 and l3 represent non-negative real numbers, θ1, θ2 and θ3 are polar angles (azimuths) about the center of the pupil plane, NA represents a numerical aperture of the illumination optical system, n represents a refractive index of a medium, and 1>NA/n>l1>l2>l3≧0.

The first component of each of the above directional vectors represents a moving radius (distance) in the x-y direction, and the second component thereof represents the polar angle in the x-y direction. The third component thereof represents an element in a z direction, which can be expressed like √(1−l1²) since the length of each vector is 1.

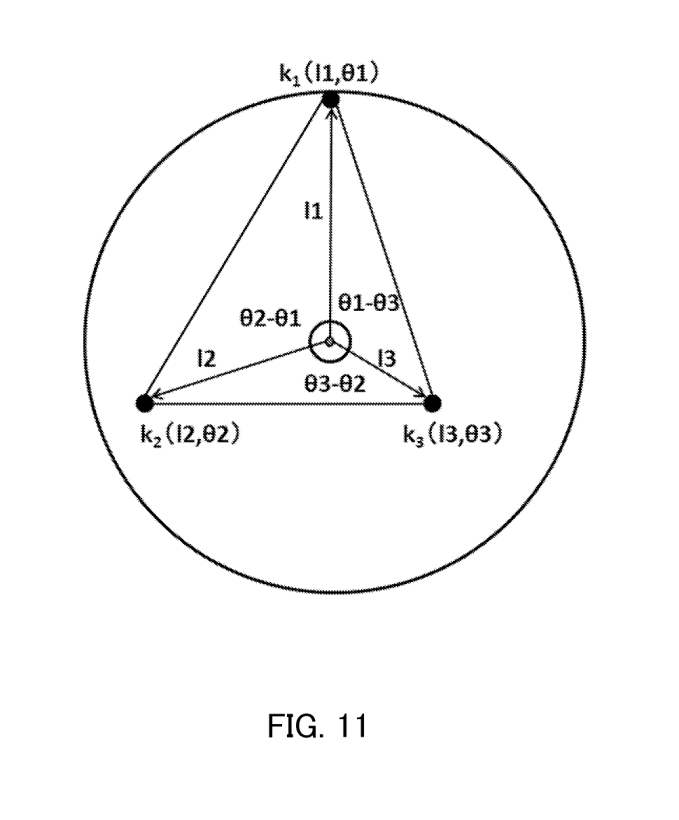

FIG. 11 shows these direction vectors on the pupil plane in a polar coordinate system. Coordinates k1(l1,θ1), k2(l2,θ2) and k3(l3,θ3) on the pupil plane are arranged inside the pupil plane normalized by the radius of NA/n. In addition, the components of k1, k2 and k3 correspond to the first and second components of the directional vectors represented by expression (4). In the following description, the light source regions are expressed as components k1, k2 and k3 of the pupil function P, and positions of these components k1, k2 and k3 are expressed by using coordinates thereof.

Next, description will be made of a relation between the components k1, k2 and k3 of the pupil function P and an interference light that illuminates the object. Firstly, a period of the intensity distribution of the illumination light formed by the pupil function P becomes finer as an area of a triangle formed by connecting three points corresponding to the components k1, k2 and k3 increases, which is advantageous for a resolution capability in the x-y direction. Secondly, a shift amount of a phase of each of the components k1, k2 and k3 of the pupil function P from which the illumination light flux is projected to a position shifted in the z direction from the in-focus plane of the object becomes larger as the distances l1, l2 and l3 from the center of the pupil plane increases. The phases of the components k1, k2 and k3 of the pupil function P are respectively shifted by amounts proportional to 1−√(1−l1²), 1−√(1−l2²) and 1−√(1−l3²) with respect to a shift amount of the z coordinate. Therefore, relative phase differences of the components of the pupil function P become more significant as differences among l1, l2 and l3 increase, and the intensity distribution of the illumination light has a larger angle with respect to an optical axis as the relative phase differences increase, which makes the sectioning effect stronger.

Since both of the above-described two relations affect quality of a finally produced image, it is necessary to provide the conditions which satisfy the two relations as much as possible. This embodiment provides the following first to third conditions to be satisfied in order to provide a good image.

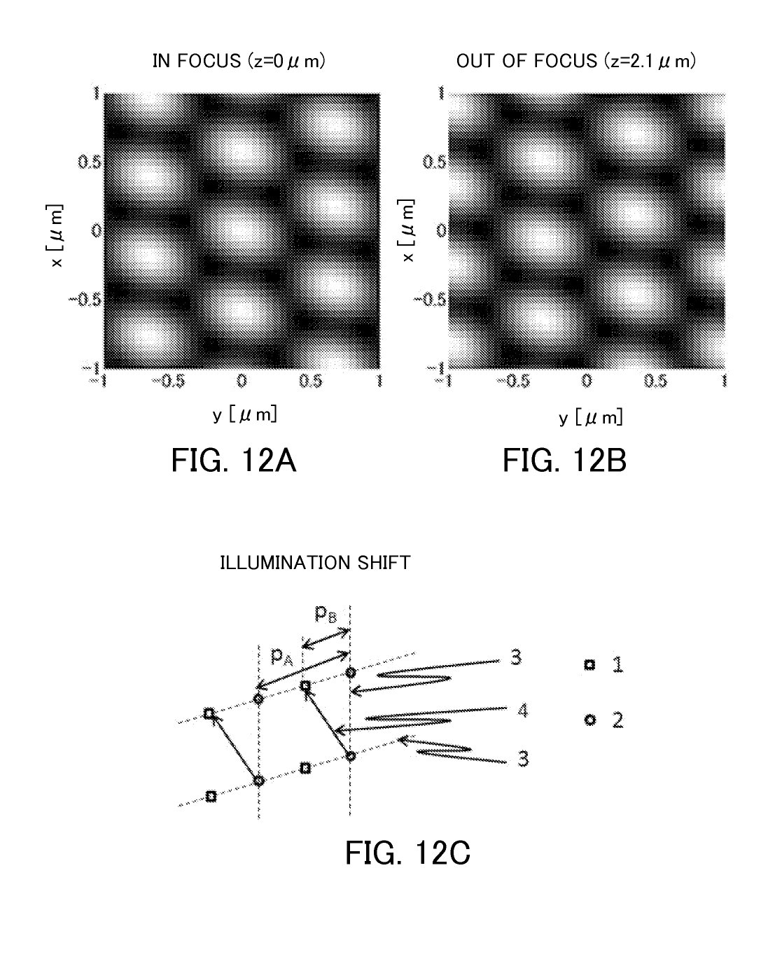

First, the first condition will be described with reference to FIGS. 12A, 12B and 12C. The first condition is that the intensity distribution in the x-y direction of the illumination light projected to the in-focus plane and that of the illumination light projected to the position shifted from the in-focus plane in the z direction do not overlap each other as much as possible.

FIGS. 12A and 12B each show an example of an intensity distribution in an x-y coordinate plane formed by the illumination lights projected from three directions from three light source regions which are coherent to each other and asymmetrically arranged on the pupil plane. FIG. 12A shows the intensity distribution in the x-y direction formed by the illumination lights projected to the in-focus plane, and FIG. 12B shows the intensity distribution in the same direction formed by the illumination lights projected to the position shifted from the in-focus plane in the z direction. FIG. 12C shows coordinates at which peak intensities of the respective intensity distributions appear. FIG. 12C schematically shows the lateral shift of the intensity distribution of the illumination light with a positional change of the illumination pattern (periodic pattern) in the z direction. Reference numeral 1 denotes intensity peaks of the periodic pattern on the in-focus plane, and reference numeral 2 denotes intensity peaks of the periodic pattern on an x-y plane shifted in the z direction from the in-focus plane. In addition, reference numeral 3 denotes a grid forming the periodic pattern, and arrows denoted by reference numeral 4 indicate a movement direction (shift direction) and a movement amount (shift amount) of the intensity peak due to the shift in the z direction.

FIG. 12C shows that, when the position in the z direction is shifted by a certain amount from the in-focus plane, the shift amount in of the illumination light defined by the arrow 4 corresponds to one period of the grid pattern 3. The shift direction is defined by a value of p_{B}/p_{A}. The condition that the illumination lights shifted in the lateral (x-y) direction do not overlap each other in the z direction is expressed as follows:

p_{B}/p_{A}=0.5, and

satisfying this condition most greatly contributes to the sectioning effect. The value of p_{B}/p_{A} represented by p can be expressed by the expression (5):

$$p = \frac{\sqrt{1 - l {2}^{2}} - \sqrt{1 - l {1}^{2}}}{\sqrt{1 - l {3}^{2}} - \sqrt{1 - l {1}^{2}}} \qquad ( 5 )$$

where p is a value from 0 to 1. A smaller value of p makes l2 closer to l1, and a larger value of p makes l2 closer to l3. A value of p away from 0.5 reduces the sectioning effect since the intensity peak 1 of the periodic pattern on the in-focus plane and the intensity peak 2 of the periodic pattern on the x-y plane shifted from the in-focus plane in the z direction overlap each other.

Accordingly in order to provide a sufficient sectioning effect, it is desirable that p satisfy the following condition expressed by expression (6):

0.4≦p≦0.6 (6)

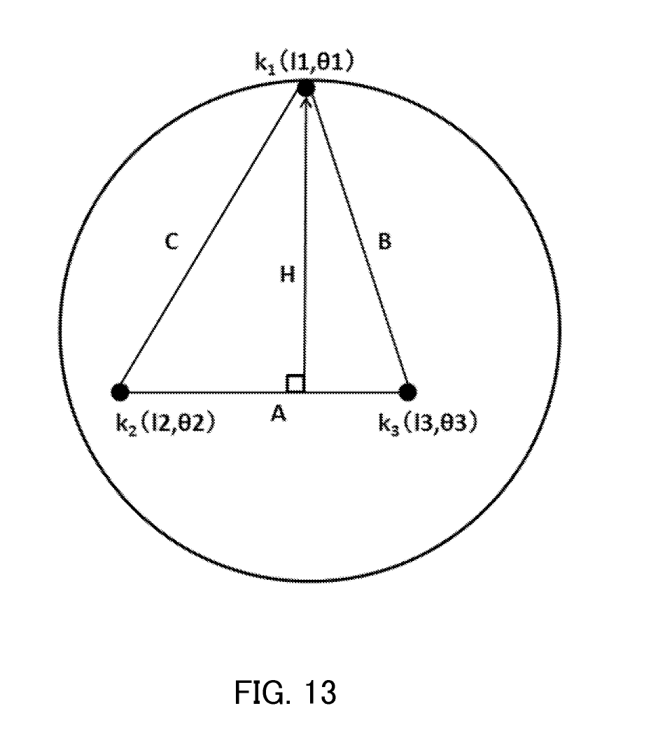

Next, description of the second condition will be made with reference to FIG. 13. The second condition is that the area of the triangle formed by connecting the positions (coordinates) of the components k1, k2 and k3 of the pupil function P is maximized as described above.

The area S of the triangle is represented as follows:

$$S = \frac{1}{2} \{ l 1 l 2 sin ( θ1 - θ2 ) + l 2 l 3 sin ( θ2 - θ3 ) + l 3 l 1 sin ( θ3 - θ1 ) \} . \qquad ( 7 )$$

When values of l1, l2 and l3 are given, the following two cases of maximizing the area S by using the polar angles of the respective components k1, k2 and k3 as variables are considered.

In the first case, l3 is not equal to 0. The condition to maximize the area S corresponds to that the area S becomes a maximum value with respect to θ1, θ2 and θ3. Thus, the following expressions (8) and (9) are derived:

$$\begin{matrix}l 1 l 2 l 3 {q}^{3} - ( l {1}^{2} + l {2}^{2} + l {3}^{2} ) {q}^{2} + 1 = 0 & ( 8 ) \\ q = \frac{cos ( θ2 - θ3 )}{l 1} = \frac{cos ( θ3 - θ1 )}{l 2} = \frac{cos ( θ1 - θ2 )}{l 3} & ( 9 )\end{matrix}$$

where q is a parameter and satisfies a relation of −l3≦q≦0.

Since relative values of the polar angles of the three light fluxes are derived by expression (8), arbitrarily deciding one polar angle automatically decides the remaining two polar angles. In FIG. 11, for viewability, the polar angle θ1 is set to 90°. Since this value is used to decide the relative polar angle, other values may be used.

In the second case, l3 is equal to 0. Substituting l=0 into expression (8), S is represented by the following expression (10):

$$S = \frac{1}{2} \{ l 1 l 2 sin ( θ1 - θ2 ) \} . \qquad ( 10 )$$

According to expression (10), the condition to maximize the area S is that θ1-θ2 be equal to ±90° (θ3 is not defined). Since absolute values of θ1 and θ2 are arbitrary values, in order to decide the polar angles, for example, as in the first condition, θ1 may be set to 90°.

The solution of the second case is also a solution of a case where the value of l3 approaches 0 as much as possible in expressions (8) and (9) representing the first condition. Therefore, in the second condition, it is possible to obtain an approximate solution by inserting a positive number which approaches 0 up to the utmost limit into l3 and solving the mathematical formulas (8) and (9). The value of θ3 derived in this case has essentially no meaning.

As a final condition, the third condition will be described with reference to FIG. 13. In calculation of the dispersion value map σ(x,y,z), equalizing the periods of the intensity distributions of the illumination light in the x and y directions to each other makes it possible to produce a map with less azimuth dependence of resolution. FIG. 13 shows an example of such a pupil function. In a triangle having vertices corresponding to the coordinates of k1, k2 and k3 which represent directions of the light fluxes reaching the pupil plane, sides thereof are defined by A, B and C in an ascending order of lengths, and a height is defined by H when the side A is set as a base of the triangle. In such a definition, the condition to equalize the periods of the intensity distributions of the illumination light in the x and y directions to each other is that r representing H/A be 1. In combination of this condition with the second condition, the side connecting the vertices k2 and k3 becomes the side A, and the side H passes through the center of the pupil.

The third condition is expressed, using the parameter q used in the above-described expression (9), by the following expression (11):

r²(l2²+l3²)−l1²+2(1−r²)l1l2l3q−l2²l3²q²=0 (11)

0.91≦r≦1.1. (12)

Then, it is possible to decide l1, l2, l3 and q by using expressions (8), (11) and (12).

As shows by expression (12), a value of r closer to 1 makes it possible to make the periods of the intensity distributions of the illumination light in the x and y directions closer to each other. This range of r makes it possible to provide an image having no resolution depending on an azimuth of the x-y plane with respect to a sensor array having a square arrangement.

Although a height H_{BC} of a triangle having the side B or the side C as the base is set, since the H_{BC} necessarily becomes shorter than the length of the side A due to geometric conditions, H_{BC}<A<B<C is established. Therefore, a ratio of the height H_{BC} to the side B or C does not become 1.

It is necessary to decide arrangement of the components of the pupil function P so as to satisfy, among the first to third conditions described above, the first and second conditions, the first and third conditions or all the first to third conditions. In general, as the value of l1 becomes smaller, the value of l2 also becomes smaller, which provides, to the intensity distribution of the illumination light, an angle with respect to the optical axis. On the contrary, as the value of l1 becomes larger, the value of l2 also becomes larger, which increases the area of the triangle formed by the components of the pupil function P. In this manner, since there is a trade-off relation between the area of the triangle and a size of the angle of the illumination light with respect to the optical axis, the pupil function P for provision of a good image can be decided while considering the balance.

Using the illumination satisfying at least two conditions among the first to third conditions in combination with the method disclosed in Daryl Lim, Kengyeh K. Chu, and Jerome Mertz, “Wide-field fluorescence sectioning with hybrid speckle and uniform-illumination microscopy,” Opt. Lett. 33, 1819-1821 (2008) and Daryl Lim, N. Ford, Kengyeh K. Chu, and Jerome Mertz, “Optically sectioned in vivo imaging with speckle illumination HiLo microscopy” Journal of Biomedical Optics. 16, 016014 (2011) makes it possible to project the grid-like illumination light having a small (almost no) intensity unevenness to the object plane. Thereby, it is possible to achieve a three-dimensional fluorescence microscope capable of providing a good image due to a high-quality sectioning effect without requiring a high degree of accuracy for scanning of the object plane and the illumination optical system.

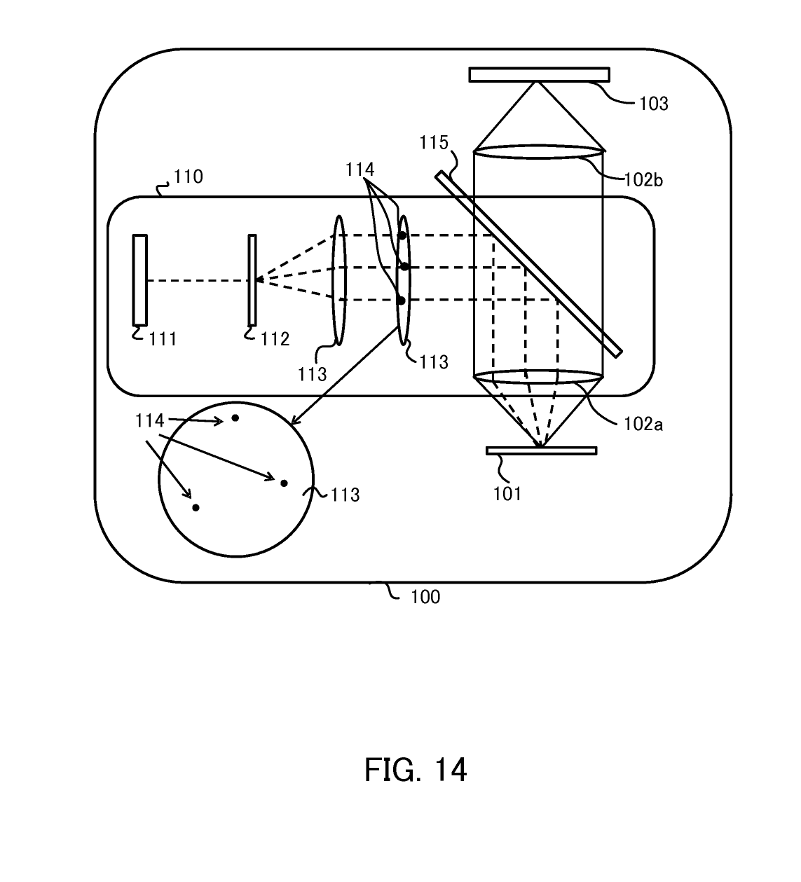

Next, description will be made of a configuration of the illumination optical system of this embodiment appropriate for a three-dimensional fluorescence microscope with reference to FIG. 14. Reference numeral 100 denotes an epi-illumination three-dimensional fluorescence microscope using the illumination optical system 110 of the above embodiment. As described above, the microscope may be a transmitted illumination microscope.

The illumination optical system 110 can be added later to a microscope main body including objective lenses 102a and 102b forming an imaging optical system and an image sensor 103. Reference numeral 101 denotes an object (sample) placed on an object plane.

In the illumination optical system 110, reference numeral 111 denotes a coherent light source such as a laser having a wavelength capable of exciting a fluorescent sample. Reference numeral 112 denotes a spectroscopic element such as a prism or a diffraction grating, which has a function of splitting one beam emitted from the light source 111 into three beams. The spectroscopic element 112 is not limited to the prism or the diffraction grating, and any element capable of implementing the above-described components (light source regions k1, k2 and k3) 114 of the pupil function on a pupil plane 113 of the illumination optical system 110 may be used. The components of the pupil function in this embodiment can be realized by a method which is easy for engineers relating to microscopes or semiconductor exposure apparatuses. For example, it is possible to use a computer generated hologram (CGH).

The three beams split by the spectroscopic element 112 are reflected by a dichroic mirror 115 and pass through the objective lens 102a so as to illuminate the object 101 with a grid-like illumination light intensity distribution. Fluorescence emitted from the object 101 passes through the objective lens 102a and the dichroic mirror 115, and then passes through the objective lens 102b to reach the image sensor 103.

In this manner, the illumination optical system of the above embodiment can be added later to the fluorescent microscope body with a simple configuration. Moreover, since the grid-like illumination light intensity distribution is accumulated in a region containing it even though it is slightly misaligned, the misalignment of the intensity distribution does not affect the final image quality.

Furthermore, as disclosed in U.S. Patent Application Publication No. 2010-0224796, the three-dimensional fluorescence microscope 100 may be replaced with an industry-dedicated microscope for acquiring reflected light from an object.

### Embodiment 2

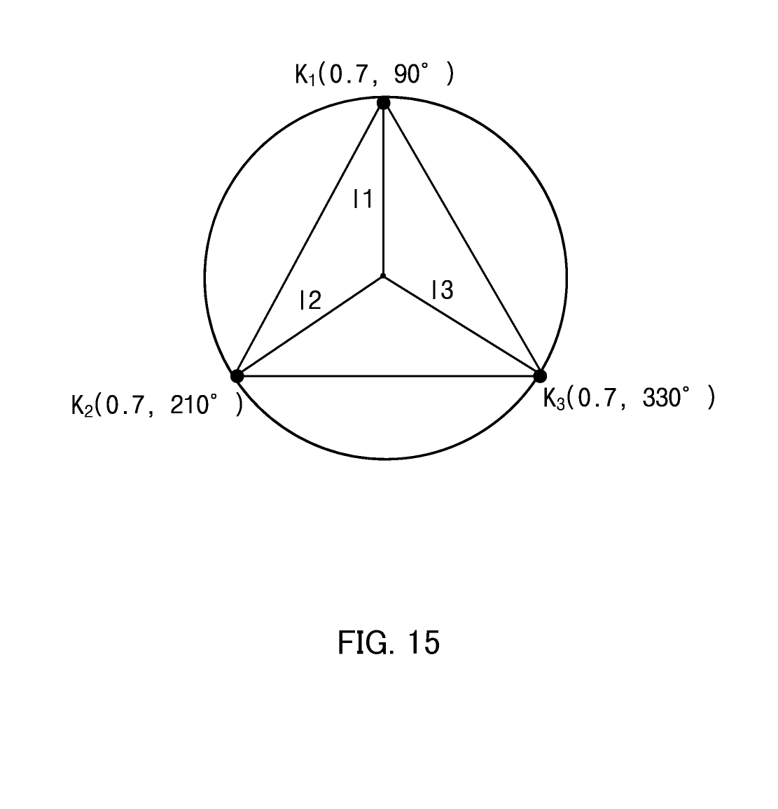

A second embodiment (Embodiment 2) of the present invention compares, in the method disclosed in Daryl Lim, Kengyeh K. Chu, and Jerome Mertz, “Wide-field fluorescence sectioning with hybrid speckle and uniform-illumination microscopy,” Opt. Lett. 33, 1819-1821 (2008) and Daryl Lim, N. Ford, Kengyeh K. Chu, and Jerome Mertz, “Optically sectioned in vivo imaging with speckle illumination HiLo microscopy” Journal of Biomedical Optics. 16, 016014 (2011), a case (comparison example) of using an illumination shown in FIG. 15 in which components k1 to k3 of a pupil function have rotational symmetry with respect to an origin and all moving radii l1 to l3 are 0.7 and a case (embodiment) of using an illumination in which the pupil function is decided on a basis of the above-described first and second conditions. In the following description, as optical parameters in the illumination optical system 110 shown in FIG. 14, a wavelength λ of 512 nm, an NA of the illumination optical system of 0.7, an NA of an objective lens of 0.7 and a refractive index n of a medium of 1 are given. In addition, as an object (sample) O, a three-dimensional fluorescent structure (not shown) having a three-dimensional structure with a thickness of 4 μm is used.

This embodiment evaluates structural similarity (hereinafter referred to as “SSIM”) by using, as a reference image, an image formed by a confocal optical system whose objective lens has an NA of 0.7 and which has an ideal resolution. This embodiment compares imaging performances using the aforementioned two pupil functions in a manner that, as a numerical value of the SSIM becomes larger, image quality becomes better.

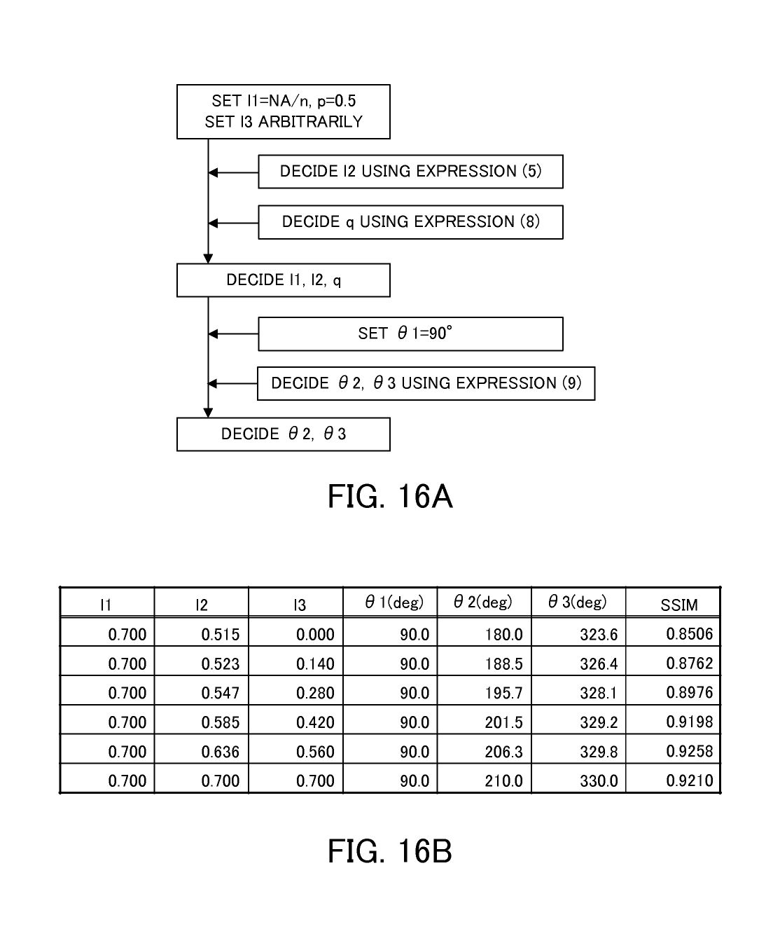

FIG. 16A shows a process of deciding the pupil function P in this embodiment. It is desirable for the arrangement of the three components k1, k2 and k3 of the pupil function P to set l1 as large as possible, since the area of the triangle formed by these components on the pupil plane is large and thereby the asymmetry of the pupil function P with respect to the origin can be maximized. In this embodiment, l1 is set to a value of (NA of the illumination optical system)/n=0.7. In addition, p in expression (6) is set to 0.5. As to l3, an arbitrary value in a range of 0≦l3<l1(=0.7) is set as an input variable.

Next, l2 is obtained by substituting l1, l3 and p into expression (5). In addition, a cubic equation including q as a variable is solved by substituting l1, l2 and l3 into expression (8). This equation exactly has one solution in a range of −l3≦q≦0. The solution is set to q.

Finally, the relative values of θ1, θ2 and θ3 are decided by substituting l1, l2, l3 and q into expression (9), and any one of the polar angles θ1, θ2 and θ3 is set (for example, θ1 is set to)90° to automatically decide the remaining two polar angles.

FIG. 16B shows examples of the arrangement of the pupil function P derived by the process in this embodiment and the SSIM thereof. The input variable is l3, and the remaining values are decided by the process shown in FIG. 16A. In the case of l3=0, q is approximately obtained by substituting a sufficiently small positive value ε (for example, 10⁻¹⁰) into l3. In addition, a lowest line of FIG. 16B shows an arrangement example in a case of l3=0.7, and a value of p in this case corresponds to the arrangement of the components of the pupil function as the comparison example shown in FIG. 15.

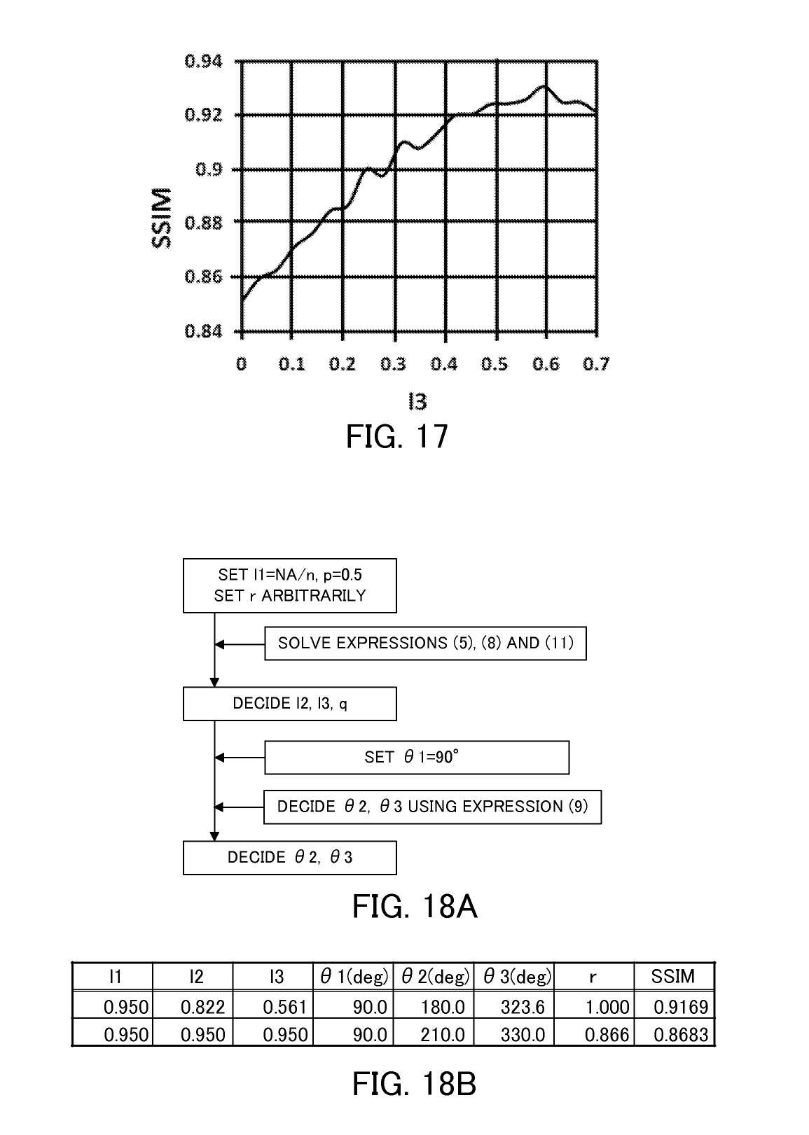

FIG. 17 shows the SSIM for images produced by using the pupil function decided by the above-described process in a confocal microscope and by using the method disclosed in Daryl Lim, Kengyeh K. Chu, and Jerome Mertz, “Wide-field fluorescence sectioning with hybrid speckle and uniform-illumination microscopy,” Opt. Lett. 33, 1819-1821 (2008) and Daryl Lim, N. Ford, Kengyeh K. Chu, and Jerome Mertz, “Optically sectioned in vivo imaging with speckle illumination HiLo microscopy” Journal of Biomedical Optics. 16, 016014 (2011). A horizontal axis denotes values of l3 as input values.

The SSIM in the case of l3=0.7 as the comparison example is 0.9167. On the other hand, when the input variable l3 is set to be smaller than 0.7, the triangle formed by the three components of the pupil function P becomes small, but the illumination light forms a distribution oblique to the optical axis. Since the latter one of the aforementioned two effects more greatly contributes to the sectioning effect in a range of 0.455≦l3<0.7, advantageous values are obtained in the case of using the pupil function having rotationally symmetric components.

### Embodiment 3

A third embodiment (Embodiment 3) of the present invention compares, in the method disclosed in Daryl Lim, Kengyeh K. Chu, and Jerome Mertz, “Wide-field fluorescence sectioning with hybrid speckle and uniform-illumination microscopy,” Opt. Lett. 33, 1819-1821 (2008) and Daryl Lim, N. Ford, Kengyeh K. Chu, and Jerome Mertz, “Optically sectioned in vivo imaging with speckle illumination HiLo microscopy” Journal of Biomedical Optics. 16, 016014 (2011), a case (comparison example) of using an illumination shown in FIG. 15 in which components k1 to k3 of a pupil function have rotational symmetry with respect to an origin and all moving radii l1 to l3 are 0.95 and a case (embodiment) of using an illumination in which the pupil function is decided on a basis of the above-described first and third conditions. In the following description, as optical parameters in the illumination optical system 110 shown in FIG. 14, a wavelength λ of 512 nm, an NA of the illumination optical system of 0.95, an NA of an objective lens of 0.95 and a refractive index n of a medium of 1 are given. In addition, as an object (sample) O, a three-dimensional fluorescent structure (not shown) having a three-dimensional structure with a thickness of 4 μm is used.

This embodiment evaluates SSIM by using, as a reference image, an image formed by a confocal optical system whose objective lens has an NA of 0.95 and which has an ideal resolution. This embodiment compares imaging performances using the aforementioned two pupil functions in a manner that, as a numerical value of the SSIM becomes larger, image quality becomes better.

FIG. 18A shows a process of deciding the pupil function P in this embodiment. For the arrangement of the three components of the pupil function P, l1 is set to 0.95 for the reason described in Embodiment 2. In addition, calculation is performed by setting the ratio r (=H/A) of the height H of the triangle, which is formed by connecting the coordinates of the three components of the pupil function P, from the shortest side A as the base of the triangle to the length of the shortest side A to 1.

The setting of r=1 is used in order to align azimuths of the periodic pattern of the sensor array 103 and the illumination light intensity distribution under an assumption that the sensor array 103 is a two-dimensional square array. Therefore, for example, in a case where the sensor array 103 is not an isotropic array, values other than r=1 may be set according to the case.

Next, simultaneous equations formed by three expressions (5), (8) and (11) are solved by setting l2, l3 and q as variables.

Although the simultaneous equations are non-linear simultaneous equations, since it is known in advance that the simultaneous equations have a solution in a range of −l3≦q≦0 and 0≦l3≦l2≦l1(=0.95), the simultaneous equations can be easily calculated by using, for example, an iteration method such as a Newton-Raphson method. In the Newton-Raphson method, setting initial values of the solution, for example, as follows makes it possible to cause the solution to immediately converge.

l2=0.8×0.95

l3=0.6×0.95

q=−0.3×0.95

After l1, l2, l3 and q are thus decided, similarly to Embodiment 2, the polar angles of the components of the pupil function P are derived by using expression (9).

FIG. 18B shows examples of the arrangement of the pupil function P derived by the process in this embodiment and the SSIM thereof. An upper line of FIG. 18B shows an arrangement example corresponding to this embodiment in which r is set to 1, and a lower line thereof shows an arrangement example corresponding to the arrangement of the components of the pupil function as the comparison example shown in FIG. 15 in which r is set to 0.866.

The SSIM in the case of using the pupil function P decided by the process of this embodiment is 0.9169 and is larger than the SSIM of 0.8683 of the comparison example, so that it is possible to confirm effectiveness of this embodiment.

As described above, each embodiment enables configuring an illumination optical system capable of projecting a grid-like illumination light with little intensity unevenness to the object plane. In addition, each embodiment achieves, by using this illumination optical system, a microscope capable of providing a high-quality sectioning effect without requiring a high degree of accuracy for scanning of the object plane and the illumination optical system.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2012-251244, filed on Nov. 15, 2012, which is hereby incorporated by reference herein in its entirety.

What is claimed is:

1. An illumination optical system to illuminate an object plane on which a sample is placed in a microscope for observation of the sample, the illumination optical system comprising:
three light source areas arranged apart from one another in a pupil plane of the illumination optical system and being coherent with one another, distances from centers of the three light source areas to a center of a pupil of the illumination optical system being different from one another,
wherein the following condition is satisfied:
$$p = \frac{\sqrt{1 - l {2}^{2}} - \sqrt{1 - l {1}^{2}}}{\sqrt{1 - l {3}^{2}} - \sqrt{1 - l {1}^{2}}}$$
where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,
$$0.4 \leq p \leq 0.6$$
$$l 1 l 2 l 3 {q}^{3} - ( l {1}^{2} + l {2}^{2} + l {3}^{2} ) {q}^{2} + 1 = 0$$
$$q = \frac{cos ( θ2 - θ3 )}{l 1} = \frac{cos ( θ3 - θ1 )}{l 2} = \frac{cos ( θ1 - θ2 )}{l 3} , and$$
$$NA / n \geq l 1 > l 2 > l 3 \geq 0.$$

2. An illumination optical system to illuminate an object plane on which a sample is placed in a microscope for observation of the sample, the illumination optical system comprising:
three light source areas arranged apart from one another in a pupil plane of the illumination optical system and being coherent with one another, distances from centers of the three light source areas to a center of a pupil of the illumination optical system being different from one another,
wherein the following condition is satisfied:
$$p = \frac{\sqrt{1 - l {2}^{2}} - \sqrt{1 - l {1}^{2}}}{\sqrt{1 - l {3}^{2}} - \sqrt{1 - l {1}^{2}}}$$
where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,
$$0.4 \leq p \leq 0.6$$
$${r}^{2} ( l {2}^{2} + l {3}^{2} ) - l {1}^{2} + 2 ( 1 - {r}^{2} ) l 1 l 2 l 3 q - l {2}^{2} l {3}^{2} {q}^{2} = 0$$
$$0.9 \leq r \leq 1.1$$
$$q = \frac{cos ( θ2 - θ3 )}{l 1} = \frac{cos ( θ3 - θ1 )}{l 2} = \frac{cos ( θ1 - θ2 )}{l 3}$$
r represents a ratio H/A in which A represents a length of a shortest side of a triangle formed by connecting the positions of the three light source areas and H represents a height of the triangle from the shortest side as a base of the triangle, and
NA/n≧l1>l2>l3≧0.

3. An illumination optical system according to claim 1, wherein the illumination optical system is used in an epi-illumination microscope or a transmitted illumination microscope.

4. An illumination optical system according to claim 2, wherein the illumination optical system is used in an epi-illumination microscope or a transmitted illumination microscope.

5. A microscope comprising:
an illumination optical system; and
an imaging optical system through which a sample placed on an object plane illuminated by the illumination optical system is observed,
wherein the illumination optical system comprises:
three light source areas arranged apart from one another in a pupil plane of the illumination optical system and being coherent with one another, distances from centers of the three light source areas to a center of a pupil of the illumination optical system being different from one another, and
wherein the following condition is satisfied:
$$p = \frac{\sqrt{1 - l {2}^{2}} - \sqrt{1 - l {1}^{2}}}{\sqrt{1 - l {3}^{2}} - \sqrt{1 - l {1}^{2}}}$$
where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,
$$0.4 \leq p \leq 0.6$$
$$l 1 l 2 l 3 {q}^{3} - ( l {1}^{2} + l {2}^{2} + l {3}^{2} ) {q}^{2} + 1 = 0$$
$$q = \frac{cos ( θ2 - θ3 )}{l 1} = \frac{cos ( θ3 - θ1 )}{l 2} = \frac{cos ( θ1 - θ2 )}{l 3} , and$$
$$NA / n \geq l 1 > l 2 > l 3 \geq 0.$$

6. A microscope comprising:
an illumination optical system; and
an imaging optical system through which a sample placed on an object plane illuminated by the illumination optical system is observed,
wherein the illumination optical system comprises:
three light source areas arranged apart from one another in a pupil plane of the illumination optical system and being coherent with one another, distances from centers of the three light source areas to a center of a pupil of the illumination optical system being different from one another, and
wherein the following condition is satisfied:
$$p = \frac{\sqrt{1 - l {2}^{2}} - \sqrt{1 - l {1}^{2}}}{\sqrt{1 - l {3}^{2}} - \sqrt{1 - l {1}^{2}}}$$
where l1, l2 and l3 represent non-negative real numbers and θ1, θ2 and θ3 represent polar angles to express, in a polar coordinate system, positions (l1,θ1), (l2,θ2) and (l3,θ3) of the three light source areas in the pupil plane having a diameter of NA/n in which NA represents a numerical aperture of the illumination optical system and n represents a refractive index of a medium,
$$0.4 \leq p \leq 0.6$$
$${r}^{2} ( l {2}^{2} + l {3}^{2} ) - l {1}^{2} + 2 ( 1 - {r}^{2} ) l 1 l 2 l 3 q - l {2}^{2} l {3}^{2} {q}^{2} = 0$$
$$0.9 \leq r \leq 1.1$$
$$q = \frac{cos ( θ2 - θ3 )}{l 1} = \frac{cos ( θ3 - θ1 )}{l 2} = \frac{cos ( θ1 - θ2 )}{l 3}$$
r represents a ratio H/A in which A represents a length of a shortest side of a triangle formed by connecting the positions of the three light source areas and H represents a height of the triangle from the shortest side as a base of the triangle, and
NA/n≧l1>l2>l3≧0.
